(19) United States
(12) Patent Application Publication
(10) Pub. No.: US 2020/0094788 A1
(43) Pub. Date: Mar. 26, 2020

(54) SNOW AND ICE MELTING DEVICE

(71) Applicant: TOYODA GOSEI CO., LTD., Kiyosu-shi (JP)

(72) Inventor: Kazuhisa TAKAHASHI, Kiyosu-shi (JP)

(21) Appl. No.: 16/536,878

(22) Filed: Aug. 9, 2019

(30) Foreign Application Priority Data
Sep. 25, 2018 (JP) 2018-178544

(51) Int. Cl. B60S 1/66

(52) U.S. Cl. CPC B60S 1/66; H05B 2214/02

(57) ABSTRACT

A snow and ice melting device includes a vehicle exterior component and an infrared irradiation portion. The vehicle exterior component is configured to be arranged in front of a light emission portion, which emits light to the outside of a vehicle, in the light emission direction. The vehicle exterior component permits light including infrared light to pass therethrough. The infrared irradiation portion is arranged inward of the vehicle exterior component and capable of irradiating infrared light to snow and ice collected on the outer surface of the vehicle exterior component.

### BACKGROUND

### 1. Field

The present disclosure relates to a snow and ice melting device that melts snow and ice collected on the outer surface of a vehicle exterior component.

### 2. Description of Related Art

Conventionally, Japanese Laid-Open Patent Publication No. 2018-100011 discloses a snow and ice melting device that melts snow and ice collected on the outer surface of a vehicle exterior component. Specifically, the device is an antifreezing device for vehicle headlights. Such an antifreezing device for vehicle headlights directly blows hot air onto snow and ice collected on the outer surface of the outer cover (vehicle exterior component) of a headlight from outside to melt the snow and ice.

However, the blow of hot air onto the snow and ice collected on the outer surface of the outer cover by the above-described antifreezing device for vehicle headlights is hindered by wind during traveling of the vehicle and rain and snow. Accordingly, the snow and ice collected on the outer surface of the outer cover are not efficiently melted.

### SUMMARY

Accordingly, it is an objective of the present disclosure to provide a snow and ice melting device that is capable of efficiently melting snow and ice collected on the outer surface of a vehicle exterior component.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a snow and ice melting device that includes a vehicle exterior component and an infrared irradiation portion is provided. The vehicle exterior component is configured to be arranged in front of a light emission portion, which emits light to an outside of a vehicle, in a light emission direction. The vehicle exterior component permits light including infrared light to pass therethrough. The infrared irradiation portion is arranged inward of the vehicle exterior component and capable of irradiating infrared light to snow and ice collected on an outer surface of the vehicle exterior component.

Other features and aspects will be apparent from the following detailed description, the drawings, and the claims.

### BRIEF DESCRIPTION OF THE DRAWINGS

FIG. 1 is a front view of a vehicle in which a vehicle radar unit is installed in the radiator grille, the radar unit being equipped with a snow and ice melting device according to an embodiment.

FIG. 2 is an enlarged partial cross-sectional side view of FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

A snow and ice melting device 29 according to an embodiment will now be described with reference to the drawings. The snow and ice melting device 29 is installed in a vehicle radar unit 20.

In the following description, the direction in which a vehicle 11 advances forward will be referred to as the front, and the reverse direction will be referred to as the rear. The vertical direction refers to the vertical direction of the vehicle 11, and the lateral direction refers to the width direction of the vehicle 11 (vehicle width direction) that matches with the lateral direction when the vehicle 11 is advancing forward.

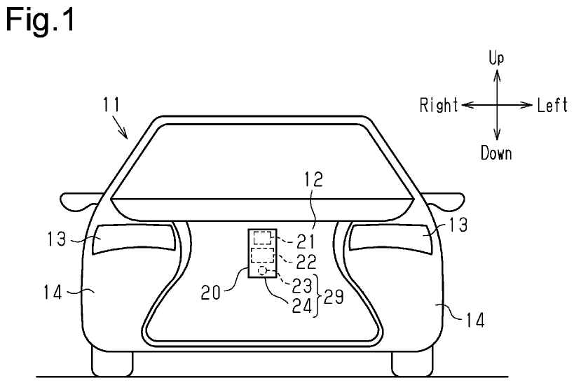

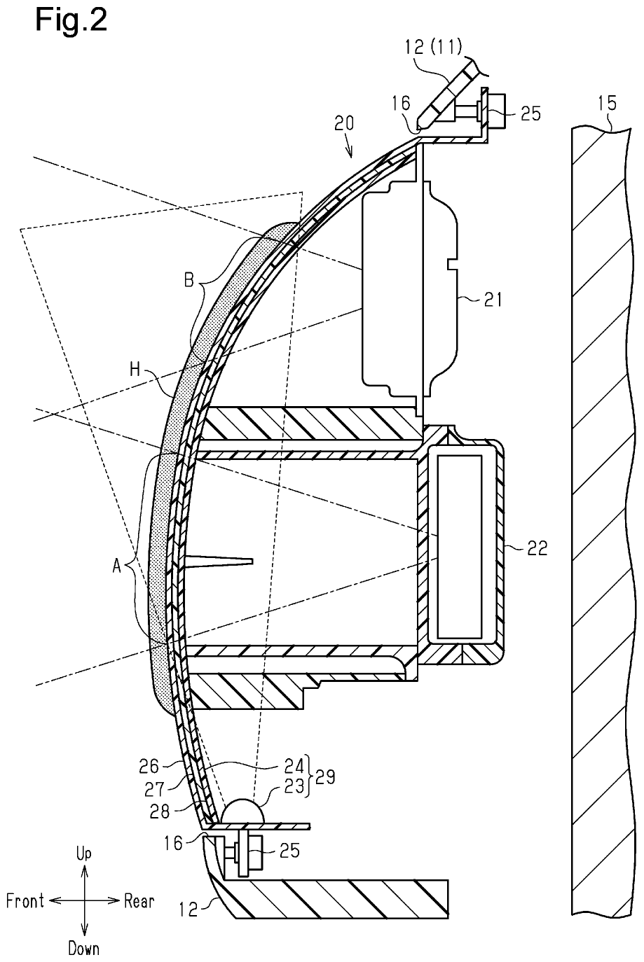

As shown in FIG. 1, the vehicle 11 includes a radiator grille 12, a pair of headlights 13, and a pair of bumper-integrated fenders 14, which are attached to the front end (outer end) of the vehicle body. The headlights 13 and the bumper-integrated fenders 14 are arranged on the left and right sides of the radiator grille 12. The radiator grille 12 has a function of guiding outside air such as relative wind to a radiator 15(see FIG. 2) to cool the radiator 15.

As shown in FIGS. 1 and 2, the radiator grille 12 has a window 16 opened in an upper portion. The vehicle radar unit 20, which has a function of detecting the environment of the vehicle 11, is installed between the window 16 and the radiator 15. The vehicle radar unit 20 includes a millimeter wave radar device 21, an infrared radar device 22, which is an example of a light emission portion, an infrared irradiation portion 23, and a cover 24, which is an example of a vehicle exterior component.

The millimeter wave radar device 21, the infrared radar device 22, and the infrared irradiation portion 23 are arranged in a line substantially in the vertical direction and are covered with the cover 24 from the front. The millimeter wave radar device 21, the infrared radar device 22, and the infrared irradiation portion 23 are attached to the cover 24 to be configured as a single unit.

The millimeter wave radar device 21 has a sensor function of transmitting millimeter waves to the outside of the vehicle 11, specifically, toward a predetermined angular range in front of the vehicle 11, and receiving millimeter waves that have struck and been reflected by an object outside the vehicle 11. Millimeter waves are radio waves with wavelengths of 1 mm to 10 mm and frequencies of 30 GHz to 300 GHz.

The millimeter wave radar device 21 detects the distance to and the relative speed with respect to the leading vehicle traveling in front of the vehicle 11 based on the time difference between the transmitted millimeter wave (transmitted wave) and the received millimeter wave (received wave), the strength of the received wave, and the like. The millimeter wave radar device 21 is characterized by being resistant to bad weather such as rain, fog, and snow, and having a longer measurable distance than other methods.

The infrared radar device 22 is arranged at a position adjacent to and below the millimeter wave radar device 21. That is, the millimeter wave radar device 21 is in alignment with the infrared radar device 22 in a direction (the vertical direction in the present embodiment) intersecting with the transmission direction of millimeter waves (the forward direction in the present embodiment). The infrared radar device 22 transmits (emits) infrared light toward an angular range wider than that of the millimeter wave radar device 21, and receives infrared light that has struck and been reflected by an object outside the vehicle 11 including a leading vehicle, a pedestrian, and the like.

Infrared light is a ray of light and has a longer wavelength than the wavelengths of visible light (0.36 μm to 0.83 μm). The infrared radar device 22 mainly detects objects closer to the vehicle 11 than objects to be detected by the millimeter wave radar device 21. The infrared radar device 22 measures the distance between the leading vehicle and the host vehicle (vehicle 11) and the relative speed with respect to the leading vehicle based on the transmitted infrared light (transmitted wave) and the received infrared light (received wave). The frequency of the infrared light used by the infrared radar device 22 of the present embodiment is set, for example, within the range from 0.2 THz to 0.33 THz.

The infrared irradiation portion 23 includes, for example, an infrared heater and is arranged below the infrared radar device 22. The infrared irradiation portion 23 is arranged outside the detection range of the millimeter wave radar device 21 and the detection range of the infrared radar device 22. The detection range of the millimeter wave radar device 21 is the range through which the millimeter waves transmitted from the millimeter wave radar device 21 pass and is also the range through which the millimeter waves that have struck and been reflected by an object pass. The detection range of the infrared radar device 22 is the range through which the infrared light transmitted from the infrared radar device 22 passes, and the range through which the infrared light that has struck and been reflected by an object passes.

The infrared irradiation portion 23 of the present embodiment is arranged at the lower end inside (behind) the cover 24. That is, the infrared irradiation portion 23 is arranged on the opposite side of the infrared radar device 22 to the millimeter wave radar 21. In other words, the infrared radar device 22 is located between the millimeter wave radar device 21 and the infrared irradiation portion 23 substantially in the vertical direction. The infrared irradiation portion 23 is configured to irradiate infrared light to certain areas of the outer surface (front surface) of the cover 24. Specifically, the infrared irradiation portion 23 is configured to irradiate infrared light at least to snow and ice H collected on an infrared passing area A, through which infrared light transmitted by the infrared radar device 22 passes, and to snow and ice H collected on a millimeter wave passing area B, through which millimeter waves transmitted by the millimeter wave radar device 21 passes.

In FIG. 2, the infrared light transmitted by the infrared radar device 22 is represented by the long dashed short dashed lines, the millimeter waves transmitted by the millimeter wave radar device 21 are represented by the long dashed double-short dashed line, and the infrared light transmitted by the infrared irradiation portion 23 is represented by the broken lines. The infrared light transmitted by the infrared radar device 22 and the infrared light transmitted by the infrared irradiation portion 23 have greatly different wavelengths and thus do not interfere with each other.

The cover 24 is formed to be more elongated in the vertical direction than in the lateral direction and is curved to bulge forward. The cover 24 is arranged in the window 16 of the radiator grille 12. The cover 24 has mounting portions 25, which are provided at least at the upper end and the lower end. The cover 24 is attached to a part of the radiator grille 12 or the vehicle body, specifically to a part around the window 16 at the mounting portions 25 by engagement using clips, screws, or hooks.

The cover 24 is located in front of the millimeter wave radar device 21, the infrared radar device 22, and the infrared irradiation portion 23 in the transmission direction of the infrared light transmitted by the infrared radar device 22 and covers the millimeter wave radar device 21, the infrared radar device 22, and the infrared irradiation portion 23. The front surface, or the outer surface, of the cover 24 is exposed to the outside of the vehicle 11 through the window 16.

The cover 24 has a three-layer structure including a base material layer 26, a decorating layer 27 formed on the back of the base material layer 26, and a sealing layer 28 formed on the back of the decorating layer 27. The base material layer 26 and the sealing layer 28 are composed of a transparent plastic such as polycarbonate (PC) plastic, polymethacrylic acid methyl (PMMA) plastic, or cycloolefin polymer (COP) plastic, and have transparency to millimeter waves, infrared light, and visible light.

The decorating layer 27 is composed of a luster layer and a colored layer. The luster layer is composed of a cold mirror layer, and the colored layer is formed by an infrared transparent ink layer. The cold mirror layer and the infrared transparent ink layer have transparency to infrared light and millimeter waves but blocks visible light. The colored layer of the decorating layer 27 may be replaced by a colorless layer that has transparency to infrared light, millimeter waves, and visible light.

The cover 24 of the present embodiment has transparency to both millimeter waves from the millimeter wave radar 21 at least in a frequency range from 30 GHz to 300 GHz and infrared light from the infrared radar device 22 at least in a frequency range from 0.2 THz to 0.33 THz. In this case, the cover 24 is preferably configured such that the attenuation rate when millimeter waves pass through the cover 24 is less than or equal to 2.5 dB and that the transmittance when infrared light passes through the cover 24 is greater than or equal to 70%.

In the present embodiment, the snow and ice melting device 29 is constituted by the cover 24 and the infrared irradiation portion 23, which is arranged inward of the cover 24 and capable of irradiating, through the cover 24, infrared light to snow and ice H collected on the outer surface of the cover 24. Therefore, the snow and ice melting device 29 is incorporated in the vehicle radar unit 20.

The vehicle 11 is equipped with an electronic control unit (not shown). The electronic control unit is electrically connected to the millimeter wave radar device 21, the infrared radar device 22, and the infrared irradiation portion 23, which have been described above. The electronic control unit executes various types of processes to support the driving of the vehicle 11 according to the environment of the vehicle 11, which is obtained from output signals of the millimeter wave radar device 21 and the infrared radar device 22.

The processes include a process of warning that the vehicle 11 may deviate from the lane, a process of warning that the vehicle 11 may collide, and a process of automatically adjusting the distance between vehicles. The vehicle 11 has sensors (not shown) for detecting the outside temperature and the weather (rain, snow, and the like), which are each electrically connected to the electronic control unit, and the electronic control unit selectively turns on and off the infrared irradiation portion 23 according to the outside temperature and the weather.

Operation of the vehicle radar unit 20, which is configured as described above, will now be described.

The millimeter wave radar device 21 of the vehicle radar unit 20 transmits millimeter waves to the outside of the vehicle 11. The millimeter waves pass through the cover 24, which is located in front of the millimeter wave radar device 21 in the transmission direction of millimeter waves. The millimeter waves that have struck and been reflected by an object such as another vehicle or an obstacle ahead in the millimeter wave transmission direction and pass through the cover 24 are received by the millimeter wave radar device 21.

Also, the infrared radar device 22 of the vehicle radar unit 20 transmits infrared light to the outside of the vehicle 11. The infrared light passes through the cover 24, which is located in front of the infrared radar device 22 in the transmission direction of the infrared light. The infrared light that has struck and been reflected by an object such as another vehicle or an obstacle ahead in the infrared light transmission direction and passes through the cover 24 is received by the infrared radar device 22.

When the outside temperature is low and the vehicle 11 is traveling on the road where snow is falling, snow and ice H collects on the cover 24. Particularly, if snow and ice H collects on the infrared passing area A and the millimeter wave passing area B on the outer surface of the cover 24, the snow and ice H hampers transmission of the millimeter waves by the millimeter wave radar device 21 and transmission of infrared light by the infrared radar device 22. This significantly reduces the accuracy of detection of an object by the millimeter wave radar device 21 and the accuracy of detection of an object by the infrared radar device 22.

In contrast, in the vehicle radar unit 20 of the present embodiment, when the outside temperature and the weather are in a condition in which snow and ice H collects on the outer surface of the cover 24, the electronic control unit (not shown) turns on the infrared irradiation portion 23 from the off state. Then, the infrared irradiation portion 23 directly irradiates infrared light onto the snow and ice H collected on the infrared passing area A and the millimeter wave passing area B on the outer surface of the cover 24.

This effectively applies heat to the snow and ice H, thereby efficiently melting the snow and ice H so that it flows down promptly. Thus, the transmission of millimeter waves by the millimeter wave radar device 21 and the transmission of infrared light by the infrared radar device 22 are no longer hampered by the snow and ice H. Accordingly, the accuracy of detection of an object by the millimeter wave radar device 21 and the accuracy of detection of an object by the infrared radar device 22 are maintained.

Various types of patterns may be printed on the outer surface of the cover 24 (front surface of the base material layer 26) with an ink that is heated when absorbing infrared light. In this case, the patterns printed on the cover 24 include a pattern in which vertically extending straight lines are spaced apart in the lateral direction, a pattern in which laterally extending straight lines are spaced apart in the vertical direction, a pattern in which diagonally extending straight lines are spaced apart and parallel to each other, a pattern in which dots are arranged regularly or irregularly, a lattice (net) pattern formed by straight lines, a pattern in which straight lines and curved lines are combined. This configuration allows the outer surface of the cover 24 to be intensely heated by irradiation of infrared light, so that the snow and ice H collected on the cover 24 is further efficiently melted.

The above-described embodiment achieves the following advantages.

(1) The infrared irradiation portion 23 of the snow and ice melting device 29 is arranged inward of the cover 24 and is configured to irradiate infrared light at least to the infrared passing area A and the millimeter wave passing area B on the outer surface of the cover 24. Generally, if snow and ice H collects on the infrared passing area A and the millimeter wave passing area B on the outer surface of the cover 24, the snow and ice H diffuses or absorbs the infrared light transmitted by the infrared radar device 22 and the millimeter waves transmitted by the millimeter wave radar device 21. This significantly reduces the accuracy of detection of an object by the millimeter wave radar device 21 and the accuracy of detection of an object by the infrared radar device 22. Thus, the snow and ice H collected on the cover 24 must be melted promptly. In this respect, since the cover 24 of the above-described configuration allows infrared light to pass through the cover 24, the infrared irradiation portion 23, which is arranged inward of the cover 24, is capable of directly irradiating infrared light to and applying heat at least to the infrared passing area A and the millimeter wave passing area B on the outer surface of the cover 24. Since the snow and ice H collected on the outer surface of the cover 24 is melted efficiently, the accuracy of detection of an object by the infrared radar device 22 and the millimeter wave radar device 21 is maintained.

(2) The cover 24 of the snow and ice melting device 29 includes the decorating layer 27, which prevents the millimeter wave radar device 21, the infrared radar device 22, and the infrared irradiation portion 23 from being visible from the front in the transmission direction of the infrared light and the millimeter waves. This improves the appearance of the vehicle radar unit 20 and its surroundings in the vehicle 11.

Modifications

The above-described embodiment may be modified as follows.

The millimeter wave radar device 21 may be omitted from the vehicle radar unit 20.

As long as the infrared irradiation portion 23 is arranged inward of (behind) the cover 24, the infrared irradiation portion 23 may be either directly attached to the cover 24 or spaced apart from the cover 24. In this case, the infrared irradiation portion 23 may be arranged on the side of the infrared radar device 22 or on the side or above the millimeter wave radar device 21.

The infrared irradiation portion 23 may irradiate infrared light onto snow and ice collected on areas on the outer surface of the cover 24 other than the infrared passing area A and the millimeter wave passing area B.

The snow and ice melting device 29 does not necessarily need to be provided in the vehicle radar unit 20, but may be provided, for example, in the headlight 13, the tail lamp (not shown), the direction indicator lamp (not shown), or the fog lamp (not shown). In these cases, each lamp constitutes a light emission portion, which emits light to the outside of the vehicle, and the cover covering each lamp constitutes a vehicle exterior component that is arranged in front of the light emission portion in the light emission direction and permits light including infrared light to pass through. This configuration allows the infrared irradiation portion arranged inward of each cover to directly irradiate infrared light onto the snow and ice collected on the outer surface of the cover. Thus, since heat is efficiently applied to the snow and ice collected on the outer surface of each cover, the snow and ice is melted efficiently.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A snow and ice melting device comprising:
a vehicle exterior component that is configured to be arranged in front of a light emission portion, which emits light to an outside of a vehicle, in a light emission direction, the vehicle exterior component permitting light including infrared light to pass therethrough; and
an infrared irradiation portion that is arranged inward of the vehicle exterior component and capable of irradiating infrared light to snow and ice collected on an outer surface of the vehicle exterior component.

2. The snow and ice melting device according to claim 1, wherein
the light emission portion is an infrared radar device that transmits infrared light to the outside of the vehicle and receives the infrared light that has struck and been reflected by an object outside the vehicle,
the vehicle exterior component is a cover that is arranged in front of the infrared radar device in a transmission direction of the infrared light to cover the infrared radar device, and
the infrared irradiation portion is arranged inward of the cover and is configured to irradiate infrared light at least to an area on an outer surface of the cover through which the infrared light transmitted by the infrared radar device passes.
